(19) United States
(12) Patent Application Publication
(10) Pub. No.: US 2009/0024979 A1
(43) Pub. Date: Jan. 22, 2009

(54) Method and system for configuring a user interface

(75) Inventors: Amanda E. Chessell, Alton (GB); Fazleabbas Kanji, Harrow (GB); Nicholas C. Maynard, Southampton (GB); Katie Shepherd, Eastleigh (GB); Simen Svennebye, Glasgow (GB); William J. Thompson, Oxford (GB); Kamorudeen L. Yusuf, Eastleigh (GB)

Correspondence Address: Useful Arts IP;Michael Ure, 10518 Phil Place, Cupertino,, CA, 94014, US

(73) Assignee: INTERNATIONAL BUSINESS MACHINES CORPORATION, Armonk, NY (US)

(21) Appl. No.: 12/173,009

(22) Filed: Jul. 14, 2008

(30) Foreign Application Priority Data
Jul. 20, 2007 (EP) 07112820.1

(51) Int. Cl. G06F 9/44

(52) U.S. Cl. 717/104

(57) ABSTRACT

A method and system are provided for configuring a user interface to a user role. A user model defines one or more user roles and one or more tasks, each user role being linked to: one or more user tasks via one or more user goals, and a set of skills a user performing the role must have, wherein each task is also linked to one or more skills. A software product defines one or more software functions, and means are provided for linking each user task to a sequence of software function calls. The system includes an organization modeling tool including means for customizing the user model dynamically to alter the user role to task mapping to meet the current needs of an organization including validating the goals and sets of skills of the user model. The system also includes a display structure model including means for configuring a user interface to a user role, the display structure model being a runtime component for dynamically building control menus for groups of tasks depending on the user role of the logged on user.

### BACKGROUND

This invention relates to the field of configuring a user interface. In particular, it relates to configuring a user interface to reflect user roles.

Software products often define users with different roles. A common set of roles for users is generally defined by the software development team in order to provide consistency in the designs when supporting each role.

However, organizations often find it necessary to restructure the way they are organized and the roles that people perform within them. This can be due to a wide range of factors and influences, for example, changes in personnel, new opportunities or challenges to address, expanding or downsizings an organization, etc. Known software systems can make organizational change difficult because people become tied to their roles as defined by the software tools they use.

It is known to provide a user model which defines user roles with tasks linked to a role. A task to software function map defines one or more software functions of the software product and one or more tasks and each software function is linked to a task.

A problem arises in that a user model may be defined at the technical level in code with built in user role flexibility in the development environment. However, the flexibility is required at user level at the user interface. It is an aim of the present invention to bridge the gap between the user interface and the user model.

### BRIEF SUMMARY

According to a first aspect of the present invention there is provided a method for configuring a user interface, comprising: providing a user model defining one or more user roles and one or more user tasks, each user role being linked to: one or more user tasks via one or more user goals, and a set of skills a user performing the role must have, wherein each task is linked to one or more skills; defining one or more software functions of a software product, each user task being linked to a sequence of software function calls; customizing the user model dynamically to alter the user role to task mapping to meet the current needs of an organization including validating the goals and sets of skills of the user model; and configuring a user interface to a user role by providing a runtime component for dynamically building control menus for groups of tasks depending on the user role of the logged on user.

Each task may also be linked to one or more user objects and tasks and user objects may be grouped into functional domains. Configuring a user interface to a user role may include dynamically building control menus for groups of tasks grouped by one of: goal, functional domain, or object they operate on.

According to a second aspect of the present invention there is provided a system for configuring a user interface, comprising:
a user model defining one or more user roles and one or more user tasks, each user role being linked to:
one or more user tasks via one or more user goals, and a set of skills a user performing the role must have, wherein each task is linked to one or more skills; a software product defining one or more software functions, means for linking each user task to a sequence of software function calls; an organization modeling tool including means for customizing the user model dynamically to alter the user role to task mapping to meet the current needs of an organization including means for validating the goals and sets of skills of the user model; a display structure model including means for configuring a user interface to a user role, the display structure model being a runtime component for dynamically building control menus for groups of tasks depending on the user role of the logged on user.

According to a third aspect of the present invention there is provided a computer program product stored on a computer readable storage medium, comprising computer readable program code means for performing the steps of: providing a user model defining one or more user roles and one or more user tasks, each user role being linked to: one or more user tasks via one or more user goals, and a set of skills a user performing the role must have, wherein each task is linked to one or more skills; defining one or more software functions of a software product, each user task being linked to a sequence of software function calls; customizing the user model dynamically to alter the user role to task mapping to meet the current needs of an organization including validating the goals and sets of skills of the user model; and configuring a user interface to a user role by providing a runtime component for dynamically building control menus for groups of tasks depending on the user role of the logged on user.

The user model enables the specification of the user interface (UI) requirements to be independent of UI technology. This makes it easier for a product to support multiple UI technologies in a consistent manner since the code for each technology is generated from the same set of models.

### BRIEF DESCRIPTION OF THE SEVERAL VIEWS OF THE DRAWINGS

Embodiments of the present invention will now be described, by way of examples only, with reference to the accompanying drawings in which:

FIG. 1 is a schematic diagram of an example of a user model as known in the prior art;

FIG. 2 is a schematic diagram of a second example of a user model as known in the prior art;

FIG. 3 is a block diagram of a system in accordance with the present invention;

FIG. 4 is a schematic block diagram showing different environments in accordance with the present invention; and

FIG. 5 is a flow diagram of a method in accordance with the present invention.

### DETAILED DESCRIPTION

User engineering, also referred to as user modeling, allows an organization or individual to describe user roles, with attributes of responsibilities and skills. The relationships between the roles show the interaction of users. There are also defined user goals, user tasks, and user objects. For more details on a user model, see http://www.ibm.com/easy.

A user engineering model of IBM Corporation, further defines a skill set of a user and a user artifact. A skill set is a collection of skills related to one another. A user artifact is a special type of user object that is physical, such as a pdf file.

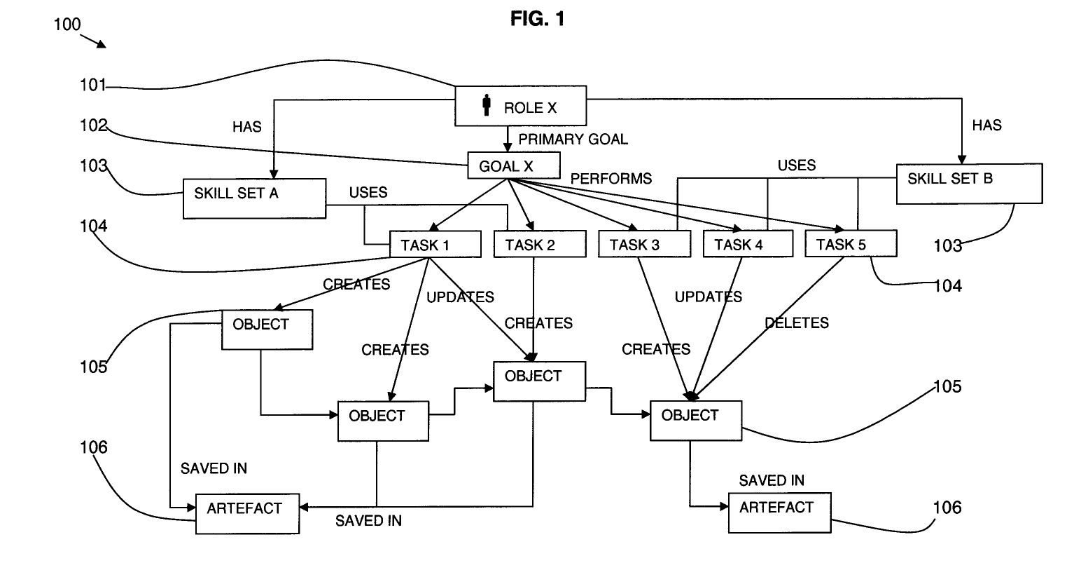

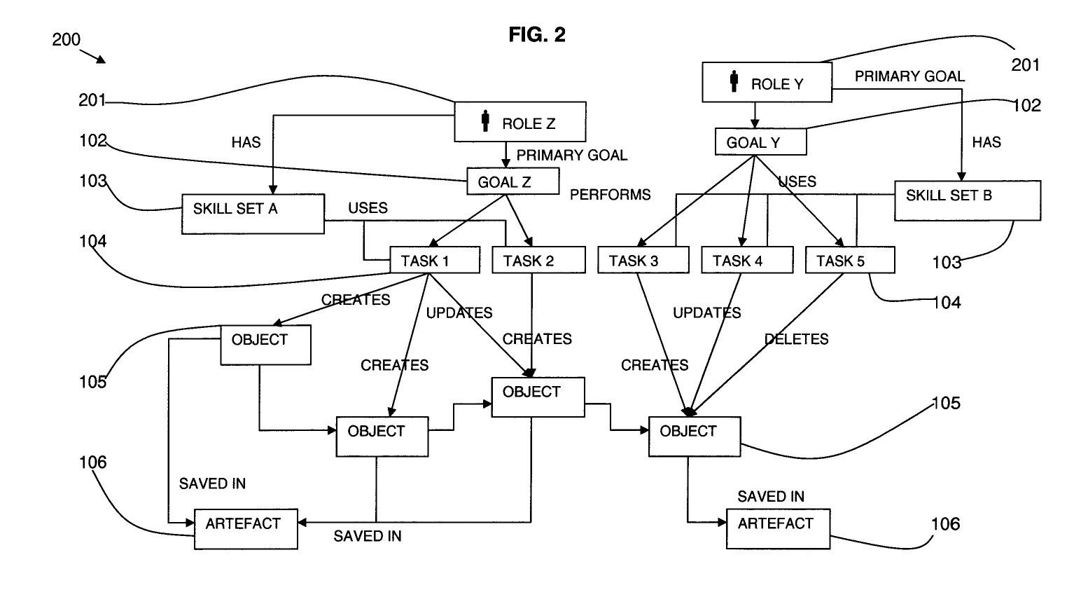

FIGS. 1 and 2 illustrate examples of user models as disclosed in the prior art. In FIG. 1, the user model 100 defines one or more user roles 101 and one or more tasks 104, each task 101 is linked to a role 101. In this example, there is a single role X, which is a highly simplified example of a user model 100 for explanation purposes. In reality, a user model for an average organization may have over one hundred different roles. The role 101 is serving a primary goal 102. The role 101 has (potentially) one to many goals 102, although in this example, only one goal 102 is shown, and the tasks 104 are linked to the goals 102. The tasks 104 linked to a specific goal 102 represent the tasks 104 that need to be completed to satisfy/achieve the respective goal 102. Each task 104 may perform an action on one or more objects 105 which are saved in the physical entities, referred to as artifacts 106.

In the organization that is being modeled in FIG. 1, the specific individual who is filling the role 101 has two skill sets 103, denoted as skill set A and skill set B. Notice this role 101 is performing all of the tasks 104 that are divided between two skill sets 103. The tasks 104 map to the functions of the software product and the product is configured (either as a permanent state or dynamically when required) relative to the role 101. This means that when any person who matches the role 101 (which could be more than one person, if there are several people within an organization filling a role who have the same skill sets 103) accesses the software product which is configured to support the functions that map to the tasks 104 that are linked to their role 101 in the user model 100.

A second example of the user model 200 is shown in FIG. 2. This second model 200 is for the same organization as before, but the previous role X of FIG. 1 has been split into two roles 201 (role Y and role Z). Each role 201 needs one of the skills sets 103 and the tasks 104 are accordingly divided between them. The change between the two user models 100, 200 of FIGS. 1 and 2 could have come about when the original role X is filled by a different person, or a reorganization of responsibilities may have taken place with the organization that is using the software product.

The tasks 104 that map to the functions of the software product have not changed, but through the medium of the skill sets 103, it can now be seen that the role Z performs only the tasks 1 and 2 in FIG. 2, and role Y performs only the tasks 3, 4 and 5. Once the organization makes a change internally, then a corresponding change to the user model 200 needs to be made to reflect the new structure within the organization. This user model 200 is specific to the particular software product whose tasks 104 are mapped in the model 200.

The net result of the organizational change is a change in the user model 200, and this is used to reconfigure the software product. This reconfiguration is either run in response to the change in the model 200, thereby effecting a permanent change in the software product, or is used when any subsequent access is made to the software product.

The configuration of the user's access does not necessarily bar them from any functionality within the software product. This concept is a design implementation issue. The software product could allow any user, regardless of role, to actually perform other tasks that are not indicated by the user model 200. What the software product does do is optimize the user's access with regard to the actual tasks that they must perform, as determined by the user model 200.

However it is equally possible that the software product is configured such that access to some functionality is disabled for certain users. This may be because it is perceived that some functionality, perhaps amending security settings, for example, is a task that when not assigned to a specific role, should not be available to anybody who is accessing the software product without the required role.

Although it is not an issue in the example of the change from FIGS. 1 to 2, but the object 105 and artifact 106 part of the user model can be used to determine if the split of tasks 104 between roles 101 is going to cause conflict between different user's access to artifacts 106 (such as a file). This would highlight the need for special locking or configuration management of the artifact 106 to control activities such as simultaneous update.

The above user models can be built as an extension of IBM's User Engineering Unified Modeling Language (UE UML). This enables a user role to be flexibly defined with its skills and responsibilities along with the user goals, user tasks, and user objects.

The present invention aims to take a user model and to generate a user interface for each role automatically. The above user model is defined at a technical level and a bridge is needed to enable a user interface to be customized at a user level to provide flexibility, for example, when restructuring roles.

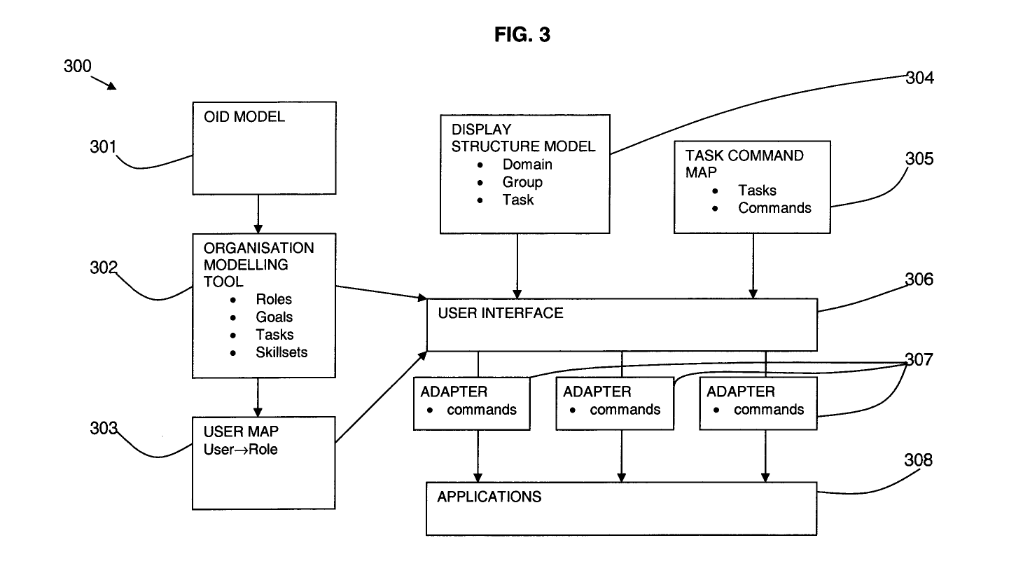

Referring to FIG. 3, a block diagram shows a system 300 including tools enabling a user interface to be configured. It is assumed that there is an outside in design (OID) user model 301 for the technology that requires a user interface (UI). An OID is a collection of methods used in software development that start from the needs of the users and work inwards to specify the internals of the system. One of the methods is user modeling or UE UML. An organization modeling tool 302 is provided which allows the alteration of the relationships between roles and tasks at deployment or production time of the UI. The organization modeling tool 302 represents the user roles, user goals, skill sets and user tasks in a simple, drag and drop interface that allows a deployer to customize the role to task mappings without knowledge of UML.

In one embodiment, the organization modeling tool 302 may have a basis provided as an eclipse modeling framework (EMF). EMF will generate a simple forms-based interface based on a metamodel (description) of the data to be worked on.

The organization modeling tool 302 is seeded from an OID user model 301 with additional indexing to show skill sets nested inside tasks and tasks nested inside skill sets. This double nesting is an important function to help the person doing the organization modeling to understand the model and to check that their changes are sensible.

Through the organization modeling tool 302, additional tasks can be defined to pull in tasks that are defined by the local organization.

The organization modeling tool 302 also supports validation rules that check the organization model. Examples of validation rules include:
1. ensuring roles have the skill sets that are needed by the user tasks they have been assigned to; and
2. ensuring that each task is covered by at least one role.

A user map 303 is provided as a model that relates one or more user roles to a specific user. The user map 303 controls the mapping from an individual user ID to the user role(s) they perform. The user map 303 separates it from the other models in the system 300 and has the advantage that it can be implemented by a standard LDAP repository typically used by organizations for their user security directory.

A display structure model 304 is provided which describes different groupings of tasks. For example, grouped by logical resource type, goals, objects they operate on, etc. Goal oriented menus can be defined in the display structure model. The user objects in the model can also provide object oriented menus, in which an object type may be selected and the task that manipulates the type of object that are also permitted for the user role are displayed.

The display structure model 304 provides the information for building menus and navigation in the UI. It has unique value because the grouping of tasks can span multiple technologies and can include locally created user tasks.

The display structure model 304 configures a UI to a user role by dynamically building control menus for groups of tasks depending on the user role of the logged on user. The display structure model 304 uses an organization model supplied by the organization modeling tool 302 using the user role information from the user map 303.

The display structure model 304 uses a user ID of the logged on user to discover the user role(s) assigned to the user. For each user role, the display structure model 304 navigates the user model to discover the user goals and user tasks for that role. This information is used to build a menu of user goals for the user with corresponding user tasks underneath it. At the end, the display structure model 304 contains the menu structures for the logged on user based on the user roles they are to perform.

The user model 303 includes user domains which groups user objects and user tasks into domains of knowledge. The display structure model 304 builds a second menu that groups all of the tasks (and their associated user objects) under their respective user domains.

A task command map 305 is provides a mapping from the user tasks in the organization modeling tool 302 to commands that control the backend technology. This task command map 305 supports the orchestration of sub-tasks and commands to build up the sequence of interactions required to task the user through a complex task which has a number of steps in it.

A UI 306 in the form of a web application brings the models and mappings together and is controlled through the models. It receives inputs from the organization modeling tool 302, the user model 303, the display structure model 304 and the task command map 305. Adapters 307 send command calls to relevant backend systems or applications 308. The models may be provided as XML-based models.

A user logs on using a user ID. If the password is correct, the UI 306 looks up the user role(s) for the user. A model of the role is determined in the organization modeling tool 302 and menus are worked out by the display structure model 304. A user selects a task to run and the task command map 305 works out which commands to issue to make calls to backend systems 308.

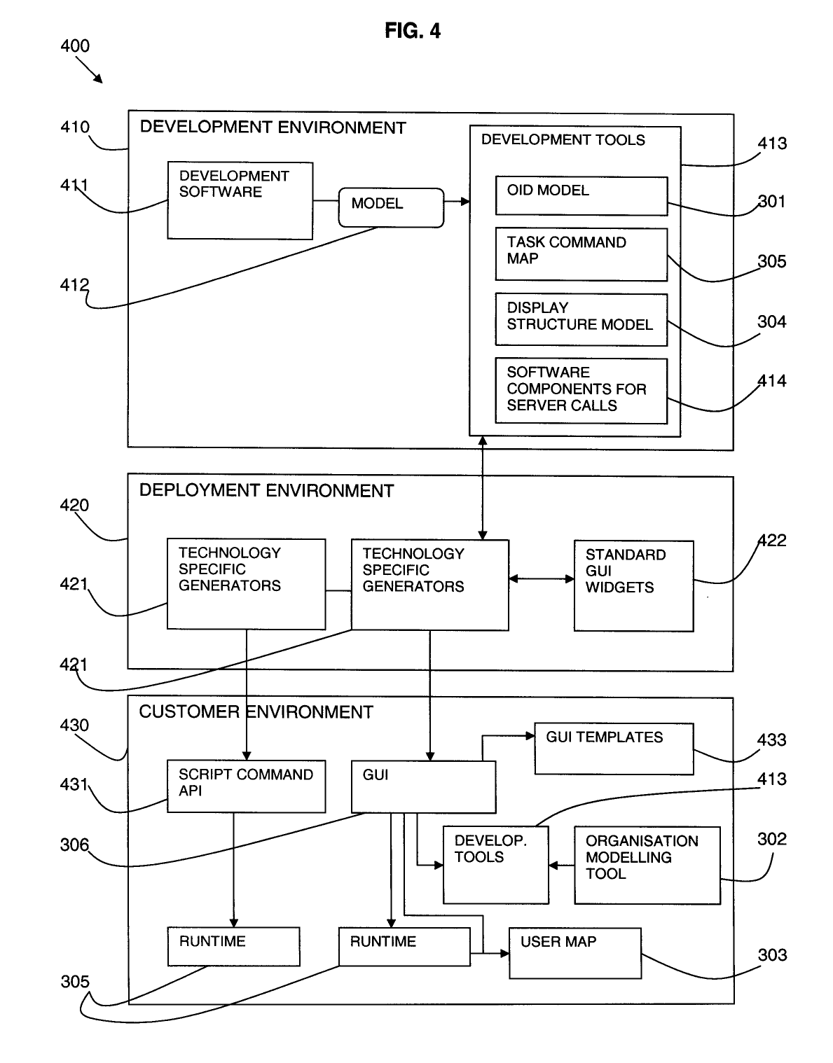

Referring to FIG. 4, a schematic block diagram 400 illustrates the method and system as used in different computer environments. At the top of the figure, a development environment 410 is shown in which development software 411 is used to provide a model instance 412 of a computer product which includes roles and tasks as described in relation to FIGS. 1 and 2.

A set of development tools 413 is provided and the development tools 413 are applied to the model 412. These include, from the models, tools, and maps shown in FIG. 3, the OID model 301, the task command map 305 and the display structure model 304. Software components 414 for server calls (for example, Java beans) are also provided as required by the model 412.

The intermediate computer environment is a deployment environment 420 which includes technology specific generator 421 which adapt the development tools 413 of the development environment 410 to the specific technology of the graphical user interface (GUI) 306. This enables the set of tools 413 of the development environment 410 to be UI technology independent, in other words, suitable for any UI technology.

The deployment environment 420 uses standard GUI widgets 422 to apply the required operations to the GUI 306.

The final computer environment is the customer environment 430 in which the organization modeling tool 302 shown in FIG. 3 uses the set of development tools 413 to customize the GUI 306 based on the role of the user. GUI templates 433 are provided and a script command API 431 is provided by the technology specific generators 421. The script command APIs and the GUI 306 call runtime applications 305. The GUI 306 also accesses the user map 303 stored in a user directory.

The described method and system provide flexibility in the delivered UI at runtime without the need to go back to the development environment to make changes.

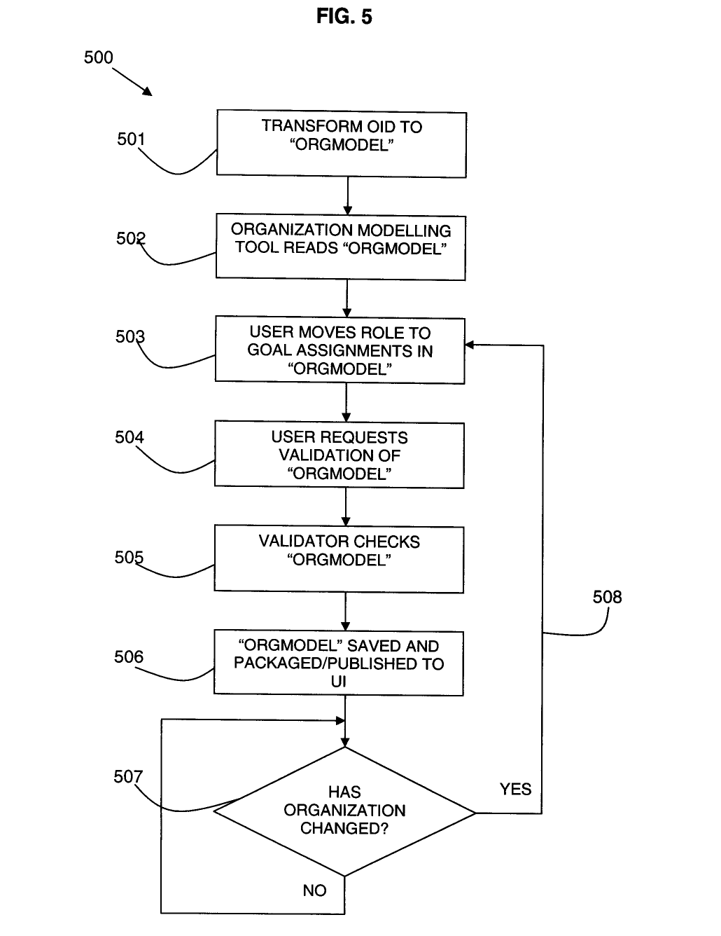

Referring to FIG. 5, a flow diagram 500 of a method of configuring a UI is provided.

A OID user model is transformed 501 from UML into an EMF model called “orgmodel”. The organization modeling tool reads 502 “orgmodel”.

A user moves 503 role to goal assignments around in the organization modeling tool to match the needs of the organization.

The user requests 504 that the new “orgmodel” is validated. The validator checks 505 that all user roles have the skills to perform the user tasks they are being asked to perform. Any inconsistencies detected are fixed by the user either by moving user goals or user tasks to different user roles, or adding new skills to the user roles.

Once correct, the “orgmodel” is saved and packaged 506 with the UI and deployed.

If the organization changes, the user can use the organization modeling tool to update the “orgmodel”. It is therefore determined 507, if the organization has changed, and, if so, the process loops 508 to rearrange the role to goal assignments 504 and re-validate 505. The new “orgmodel” is then published 506 to the UI and the users of the UI see their new user tasks and menus the next time they log on.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

The invention can take the form of a computer program product accessible from a computer-usable or computer-readable medium providing program code for use by or in connection with a computer or any instruction execution system. For the purposes of this description, a computer usable or computer readable medium can be any apparatus that can contain, store, communicate, propagate, or transport the program for use by or in connection with the instruction execution system, apparatus or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read only memory (ROM), a rigid magnetic disk and an optical disk. Current examples of optical disks include compact disk read only memory (CD-ROM), compact disk read/write (CD-R/W), and DVD.

Improvements and modifications can be made to the foregoing without departing from the scope of the present invention.

1. A method for configuring a user interface, comprising:
providing a user model defining one or more user roles and one or more user tasks, each user role being linked to:
one or more user tasks via one or more user goals, and
a set of skills a user performing the role must have,
wherein each task is linked to one or more skills;
defining one or more software functions of a software product, each user task being linked to a sequence of software function calls;
customizing the user model dynamically to alter the user role to task mapping to meet the current needs of an organization including validating the goals and sets of skills of the user model; and
configuring a user interface to a user role by providing a runtime component for dynamically building control menus for groups of tasks depending on the user role of the logged on user.

2. The method as claimed in claim 1, wherein each task is linked to one or more user objects and tasks and user objects are grouped into functional domains.

3. The method as claimed in claim 2, wherein configuring a user interface to a user role includes dynamically building control menus for groups of tasks grouped by one of: goal, functional domain, or object they operate on.

4. The method as claimed in claim 1, including indexing the user model to nest a set of skills in a task and to nest one or more tasks in a set of skills, and validating the sets of skills checks the nestings.

5. The method as claimed in claim 1, wherein the customizing includes validating to check that each user task is covered by a user role.

6. The method as claimed in claim 1, wherein customizing the user model occurs at deployment of the user interface or during production of the user interface.

7. The method as claimed in claim 1, wherein the user model is packaged with the user interface for deployment.

8. The method as claimed in claim 1, wherein changes to the user model is published to the user interface for deployment.

9. The method as claimed in claim 1, wherein configuring a user interface to a user role dynamically builds control menus which are UI technology independent.

10. A system for configuring a user interface, comprising:
a user model defining one or more user roles and one or more user tasks, each user role being linked to:
one or more user tasks via one or more user goals, and
a set of skills a user performing the role must have,
wherein each task is linked to one or more skills;
a software product defining one or more software functions, means for linking each user task to a sequence of software function calls;
an organization modeling tool including means for customizing the user model dynamically to alter the user role to task mapping to meet the current needs of an organization including means for validating the goals and sets of skills of the user model;
a display structure model including means for configuring a user interface to a user role, the display structure model being a runtime component for dynamically building control menus for groups of tasks depending on the user role of the logged on user.

11. The system as claimed in claim 10, wherein the organization modeling tool represents user roles, user tasks, user goals, and user skill sets in a drag and drop interface.

12. The system as claimed in claim 10, wherein the organization modeling tool includes means for indexing the user model to nest a set of skills in a task and to nest one or more tasks in a set of skills.

13. The system as claimed in claim 10, wherein a user model in the organization modeling tool is seeded from a user model in unified modeling language.

14. The system as claimed in claim 10, including means for saving the user model and packaging the user model with the user interface for deployment.

15. The system as claimed in claim 10, including means for saving changes to the user model and publishing them to a deployed user interface.

16. A computer program product stored on a computer readable storage medium, comprising computer readable program code means for performing the steps of:
providing a user model defining one or more user roles and one or more user tasks, each user role being linked to:
one or more user tasks via one or more user goals, and
a set of skills a user performing the role must have,
wherein each task is linked to one or more skills;
defining one or more software functions of a software product, each user task being linked to a sequence of software function calls;
customizing the user model dynamically to alter the user role to task mapping to meet the current needs of an organization including validating the goals and sets of skills of the user model; and
configuring a user interface to a user role by providing a runtime component for dynamically building control menus for groups of tasks depending on the user role of the logged on user.

17. The computer program product as claimed in claim 16, comprising computer readable program code means for performing the steps of linking each task to one or more user objects and grouping user objects into functional domains.

18. The computer program product as claimed in claim 16, comprising computer readable program code means for performing the steps of indexing the user model to nest a set of skills in a task and to nest one or more tasks in a set of skills, and validating the sets of skills checks the nestings.

19. The computer program product as claimed in claim 16, wherein the customizing includes validating to check that each user task is covered by a user role.

20. The computer program product as claimed in claim 16, wherein customizing the user model occurs at deployment of the user interface or during production of the user interface.
